(19) United States
(12) Patent Application Publication
(10) Pub. No.: US 2026/0086707 A1
(43) Pub. Date: Mar. 26, 2026

(54) METHODS AND SYSTEMS FOR MULTIMODAL DRAGGING INTERACTIONS WITH VIRTUAL OBJECTS

(71) Applicant: HUAWEI TECHNOLOGIES CO., LTD., Shenzhen (CN)

(72) Inventors: Mohi REZA, Kanata (CA); Che YAN, Kanata (CA); Soheil KIANZAD, Kanata (CA); Wei LI, Kanata (CA)

(21) Appl. No.: 19/407,092

(22) Filed: Dec. 3, 2025

Related U.S. Application Data
(63) Continuation of application No. PCT/CN2023/100385, filed on Jun. 15, 2023.

(51) Int. Cl. G06F 3/0486; G06F 3/0354; G06F 3/0482; G06F 3/04842; G06F 3/04883; G06F 3/16

(52) U.S. Cl. CPC G06F 3/0486; G06F 3/03545; G06F 3/0482; G06F 3/04842; G06F 3/04883; G06F 3/167

(57) ABSTRACT

There are provided methods and systems for multimodal dragging interactions with virtual objects. In examples, dragging interactions may be assisted by audio input in the form of voice commands. In response to detecting that a dragging gesture has been initiated, voice recognition is enabled. In examples, one or more voice commands for instructing a modification to a virtual object during a dragging gesture is received. A modification action for modifying the virtual object is determined, based on the dragging gesture and the voice command. In response to detecting a completion of the dragging gesture, the virtual object, modified using the one or more modification actions, is placed at the destination. The disclosed methods and systems may enable improved UI interaction with virtual objects, by enabling the modification of virtual objects during dragging gestures.

### CROSS-REFERENCE TO RELATED APPLICATIONS

The present disclosure is a continuation of PCT application no. PCT/CN2023/100385, filed on Jun. 15, 2023, entitled “METHODS AND SYSTEMS FOR MULTIMODAL DRAGGING INTERACTIONS WITH VIRTUAL OBJECTS”, the disclosure of which is hereby incorporated by reference in its entirety.

### TECHNICAL FIELD

The present disclosure relates to the field of human-computer interaction, in particular, methods and systems for modifying virtual objects using multimodal dragging interactions, and more particularly, using voice-assisted dragging gestures.

### BACKGROUND

The manipulation of physical objects in the real world tends to follow a sequence of three steps: (i) picking up the object from a source location, (ii) doing something with the object to manipulate it in some way, (iii) putting it down to a destination location once the manipulation is complete. The second step of manipulating the object encompasses many possibilities, including moving the object or modifying it in a myriad of ways that may be highly expressive, or which require multiple steps or actions.

A drag-and-drop interaction technique present in many graphical user interfaces (GUIs) can be considered a digital equivalent to manipulating physical objects. Similarly, drag-and-drop interaction follows the sequential nature of physical object manipulation, for example, involving three steps: (i) “picking up” the virtual object from a source by selecting the virtual object, for example, using a pointing device such as a mouse cursor or digital pen, or a finger on a touchscreen, (ii) moving the virtual object from a source to a destination by dragging the virtual object across the screen, (iii) putting the virtual object down by placing it at the destination.

However, unlike the rich and expressive nature of manipulating physical objects, manipulation of virtual objects using a drag-and-drop interaction is limited to moving the object to a different location. Modification of the object is difficult because users cannot click or tap while dragging, and must therefore configure any modification actions using menus or clicking-based interactions before or after dragging. Furthermore, the clicking-based interactions can typically be slow, tedious or complicated, for example, involving multiple clicks or navigating context menus.

Accordingly, improvements in user interaction using dragging gestures is desired.

### SUMMARY

In various examples, the present disclosure describes methods and systems for improved user interaction with virtual objects on an electronic device using dragging gestures, for example, using multiple input modes. Specifically, dragging interactions with virtual objects on an electronic device may be assisted by audio input in the form of voice commands. In response to detecting that a dragging gesture has been initiated, voice recognition is enabled. In examples, one or more voice commands for instructing a modification to a virtual object during a dragging gesture is received. A modification action for modifying the virtual object is determined, based on the dragging gesture and the voice command. In response to detecting a completion of the dragging gesture, the virtual object, modified using the one or more modification actions, is placed at the destination. The disclosed methods and systems may enable improved UI interaction and/or virtual object modification for applications enabling drag-and-drop interactions, for example, word processing or rich text editing, presentation slide creation, file management, or window management, among others.

In various examples, the present disclosure provides the technical effect that a virtual object is modified during a multimodal dragging interaction for example, by navigating a dragging gesture through one or more multimodal portal buttons and/or by issuing one or more voice commands while dragging the virtual object from source to destination. In this regard, the virtual object may be modified based on a multimodal input comprising a gesture input and an audio input.

In examples, a multimodal dragging interaction may provide advantages in making the process of modifying dragged virtual objects easier and more efficient compared to conventional clicking or tapping interactions, for example, by allowing users to modify dragged objects without clicking or going through menu lists.

In an example aspect, the present disclosure describes a computer implemented method for modifying a virtual object using a multimodal dragging interaction. The method includes: in response to detecting an initiation of a dragging gesture for moving a virtual object from a displayed source location within a graphical user interface (GUI) to a displayed destination location within the GUI, enabling voice recognition; receiving a voice command for instructing a modification to the virtual object; determining one or more modification actions for modifying the virtual object, based on the dragging gesture and the voice command; and in response to detecting a completion of the dragging gesture, placing the virtual object, modified using the one or more modification actions, at the displayed destination location.

In the preceding example aspect of the method, the GUI includes one or more interactive elements, each of the one or more interactive elements being associated with a respective selectable modification action for modifying the virtual object.

In the preceding example aspect of the method, determining the one or more modification actions comprises: determining at least one of the one or more interactive elements were traversed by a dragging path of the dragging gesture; and for each of the traversed portal elements: activating the interactive element.

In some example aspects of the method, determining the one or more modification actions comprises: determining that the voice command corresponds to a modification action associated with at least a corresponding one of the one or more interactive elements; and for each of the at least corresponding one of the one or more interactive elements: activating the portal element.

In some example aspects of the method, the method further comprises: for each activated interactive element of the one or more interactive elements: altering an appearance of the activated interactive element.

In some example aspects of the method, the method further comprises: prior to activating the interactive element: altering an appearance of the interactive element to include a parent element representing a category of modification actions and at least one child element representing at least one of the one or more modification actions.

In some example aspects of the method, the one or more interactive elements are arranged in an interactive element menu, the interactive element menu being displayed at a fixed position on a display of an electronic device.

In some example aspects of the method, the one or more interactive elements are arranged in an interactive element menu, the interactive element menu being dynamically positioned on a display of an electronic device based on a displayed location of the source.

In some example aspects of the method, the one or more interactive elements are arranged in an interactive element menu, the interactive element menu being dynamically positioned on a display of an electronic device based on the displayed location of the destination.

In some example aspects of the method, enabling voice recognition includes activating a microphone for receiving a speech signal.

In the preceding example aspect of the method, the method further comprises: in response to detecting the completion of the dragging gesture, deactivating the microphone.

In some example aspects of the method, the dragging gesture is representative of a movement of one of: a pointer within the GUI; a digital pen or stylus in contact with a touch sensitive surface of a display of an electronic device; or a finger in contact with the touch sensitive surface of the display of the electronic device.

In some aspects, the present disclosure describes a system. The system comprises: one or more processors; and a memory storing machine-executable instructions which, when executed by the processor device, cause the system to: in response to detecting an initiation of a dragging gesture for moving a virtual object from a displayed source location within a graphical user interface (GUI) to a displayed destination location within the GUI, enable voice recognition; receive a voice command for instructing a modification to the virtual object; determine one or more modification actions for modifying the virtual object, based on the dragging gesture and the voice command; and in response to detecting a completion of the dragging gesture, place the virtual object, modified using the one or more modification actions, at the displayed destination location.

In the preceding example aspect of the system, the GUI includes one or more interactive elements, each of the one or more interactive elements being associated with a respective selectable modification action for modifying the virtual object.

In the preceding example aspect of the system, wherein the machine-executable instructions, when executed by the one or more processors to determine the one or more modification actions, further cause the system to: determine at least one of the one or more interactive elements were traversed by a dragging path of the dragging gesture; and for each of the traversed portal elements: activate the interactive element.

In some example aspects of the system, wherein the machine-executable instructions, when executed by the one or more processors to determine the one or more modification actions, further cause the system to: determine that the voice command corresponds to a modification action associated with at least a corresponding one of the one or more interactive elements; and for each of the at least corresponding one of the one or more interactive elements: activate the portal element.

In some example aspects of the system, wherein the machine-executable instructions, when executed by the one or more processors, further cause the system to: for each activated interactive element of the one or more interactive elements: alter an appearance of the activated interactive element.

In some example aspects of the system, wherein the machine-executable instructions, when executed by the one or more processors, further cause the system to: prior to activating the interactive element: alter an appearance of the interactive element to include a parent element representing a category of modification actions and at least one child element representing at least one of the one or more modification actions.

In any of the preceding example aspects of the system, the dragging gesture is representative of a movement of one of: a pointer within the GUI; a digital pen or stylus in contact with a touch sensitive surface of a display of an electronic device; or a finger in contact with the touch sensitive surface of the display of the electronic device.

In some example aspects, the present disclosure describes a non-transitory computer readable medium storing instructions thereon. The instructions, when executed by a processor, cause the processor to: in response to detecting an initiation of a dragging gesture for moving a virtual object from a displayed source location within a graphical user interface (GUI) to a displayed destination location within the GUI, enable voice recognition; receive a voice command for instructing a modification to the virtual object; determine one or more modification actions for modifying the virtual object, based on the dragging gesture and the voice command; and in response to detecting a completion of the dragging gesture, place the virtual object, modified using the one or more modification actions, at the displayed destination location.

### BRIEF DESCRIPTION OF THE DRAWINGS

Reference will now be made, by way of example, to the accompanying drawings which show example embodiments of the present application, and in which:

FIG. 1 is a block diagram illustrating an example computing system which may be used to implement examples of the present disclosure;

FIG. 2 shows an example of a traditional drag-and-drop interaction within a graphical user interface (GUI);

FIG. 3 illustrates an example embodiment of a multimodal dragging interaction within a GUI, in accordance with examples of the present disclosure;

FIG. 4 shows a block diagram of an example multimodal dragging interaction system, in accordance with examples of the present disclosure;

FIGS. 5A-C illustrate example embodiments of a placement of an interaction element menu within a GUI, in accordance with examples of the present disclosure;

FIG. 6 illustrates another example embodiment of a multimodal dragging interaction within a GUI, in accordance with examples of the present disclosure;

FIG. 7 illustrates another example embodiment of a multimodal dragging interaction within a GUI, in accordance with examples of the present disclosure;

FIG. 8 illustrates another example embodiment of a multimodal dragging interaction within a GUI, in accordance with examples of the present disclosure;

FIG. 9A-D illustrate example embodiments of dragging gestures to activate one or more interaction elements in a dynamic radial interaction element menu, in accordance with examples of the present disclosure;

FIG. 10 is a flowchart illustrating an example algorithm for a multimodal dragging interaction, in accordance with examples of the present disclosure;

FIG. 11 is a flowchart illustrating an example algorithm for determining the placement and layout of an interaction element menu, in accordance with examples of the present disclosure; and

FIG. 12 is a flowchart illustrating an example method for modifying a virtual object based on a multimodal dragging gesture, in accordance with examples of the present disclosure;

Similar reference numerals may have been used in different figures to denote similar components.

### DETAILED DESCRIPTION

The following describes example technical solutions of this disclosure with reference to accompanying drawings. Similar reference numerals may have been used in different figures to denote similar components.

To assist in understanding the present disclosure, some existing techniques for interacting with virtual objects using dragging gestures are discussed.

While the majority of current graphical interfaces depend heavily on clicking-based interactions, for example, using click-select actions on interface elements such as buttons, alternative paradigms such as crossing-based interfaces may be faster or more efficient for interacting with interface elements. In examples, crossing-based interfaces can refer to interactions, where instead of clicking, users can trigger actions by crossing boundaries using a cursor or pointer. One example approach to crossing-based interfaces is described in: Accot, Johnny, and Shumin Zhai, “More than dotting the i's—foundations for crossing-based interfaces”, Proceedings of the SIGCHI conference on Human factors in computing systems, 2002, the entirety of which is hereby incorporated by reference. Crossing-based interfaces may be beneficial for menu-selection, but do not enable the modification of dragged content.

Clicking-based interfaces typically employ linear context menus, where the user is guided through a sequenced list of menu items (e.g., right-clicking on the Windows™ on MacOS™ desktop reveals a linear menu). One alternative to linear context menus includes marking menus. In examples, marking menus may enable users to perform menu selections in two ways. A radial (or pie) menu may pop-up in a GUI from which a user may select objects, or a user may generate a straight mark in the direction of the desired menu item, without popping-up the menu. One example approach to marking menus is described in: Kurtenbach, G., & Buxton, W., (1994 April), User learning and performance with marking menus, In Proceedings of the SIGCHI conference on Human factors in computing systems (pp. 258-264), the entirety of which is hereby incorporated by reference. One drawback is that marking menus do not optimize for important interface metrics that are relevant to the drag-and-drop interaction, such as the location of the source and/or destination of the dragged virtual object, and the ability to activate/deactivate modification actions while maintaining a relatively short path between those two locations.

With advances in automatic speech recognition (ASR) technology, voice-command driven editing is an approach that has been explored for manipulating text with voice. One example approach to manipulating text with voice is described in: Zhao, M., Cui, W., Ramakrishnan, I. V., Zhai, S., & Bi, X., (2021 October), Voice and Touch Based Error-tolerant Multimodal Text Editing and Correction for Smartphones, In The 34th Annual ACM Symposium on User Interface Software and Technology (pp. 162-178), the entirety of which is hereby incorporated by reference. Another example approach to manipulating text with voice is described in: Fan, J., Xu, C., Yu, C., & Shi, Y., (2021 October), Just speak it: Minimize cognitive load for eyes-free text editing with a smart voice assistant, In The 34th Annual ACM Symposium on User Interface Software and Technology (pp. 910-921), the entirety of which is hereby incorporated by reference. Existing voice-command driven editing systems typically require users to manually turn the microphone on and off, and in cases where these systems are always listening, they may become susceptible to unintentional activation of commands due to background noise, and may intrude on user privacy.

A common drawback to all of the above mentioned approaches is the requirement for multiple clicks and a need to navigate through deep or complicated context menus. Furthermore, current approaches using dragging functionality are limited to moving the dragged object. Current dragging interactions are able to move objects easily, but modification of these objects is difficult.

In some embodiments, the present disclosure describes examples that address some or all of the above drawbacks of existing techniques for interacting with virtual objects using dragging interactions.

To assist in understanding the present disclosure, the following describes some relevant terminology that may be related to examples disclosed herein.

In the present disclosure, “multimodal” can mean: comprising two or more modalities, for example, a combination of two or more modes of input data. In this regard, a multimodal input may be a single input that comprises a combination of individual inputs that were obtained from two or more different data sources, for example, comprising a gesture input and an audio input, etc.

In the present disclosure, a “dragging gesture” or a “drag gesture” can mean: a dragging motion performed while interacting with a virtual object, where the motion invokes an action. For example, a dragging gesture may be representative of a movement of a pointer in a graphical user interface (GUI), for example, a mouse cursor, a digital pen or stylus or a finger in contact with a touch sensitive surface, along a display screen, causing the movement of one or more virtual objects from a source to a destination along a dragging path. In examples, a dragging gesture may also be representative of a mid-air gesture for interaction with a virtual object within an AR/VR environment, among others. In examples, a dragging gesture may be indicated by a drag-start event, a pointer displacement along a dragging path, and a drag-stop event.

In the present disclosure, a “drag-start event” can mean: A pointer event signifying the start of a dragging gesture, for example, initiated by the selection of a virtual object by a pointer (e.g., mouse click, stylus or finger contact on a touch sensitive surface, etc.) for “picking up” the virtual object in preparation for moving the virtual object from its source.

In the present disclosure, a “drag-stop event” can mean: A pointer event signifying the end of a dragging gesture, for example, initiated by the release of a virtual object by a pointer (e.g., mouse release, removing a stylus or finger from a touch sensitive surface, etc.) at its destination.

In the present disclosure, a “dragging path” or a “dragging pattern” can mean: A sequence or series of coordinates (x,y) associated with a changing position of a pointer and/or a virtual object on a display over a period of time, for example, while the virtual object is being dragged.

In the present disclosure, a “speech signal” can mean: a non-stationary electronic signal that carries linguistic information from one or more utterances in a speaker's speech. An utterance is a unit of a speaker's speech including the vocalization of one or more words or sounds that convey meaning. Utterances may be bounded at the beginning and the end with a pause or period of silence and may include multiple words.

In the present disclosure, a “multimodal interaction element”, an “interaction element” or a “portal element” can mean: a GUI object or element that is displayed within a GUI and that is associated with a control operation within an application window, for example, associated with applying a modification action to a virtual object in response to a user interaction (e.g. dragging gesture, voice command etc.).

In the present disclosure, a “virtual object” can mean: a digital object that is displayed within a GUI or a virtual environment, that has some data associated with it and which can be manipulated, interacted with or caused to perform operations, among others. Examples of virtual objects can include: a file or folder icon, digital content such as a block of text, an image or a video, visual elements such as shapes or drawing elements, or any other element that can be described or represented as an object on a GUI.

In the present disclosure, an “entry event” can mean: A time stamp associated with a dragging gesture contacting or crossing a first interface of an interaction element, for example, where a pointer enters a space in a GUI occupied by an interaction element.

In the present disclosure, an “exit event” can mean: A time stamp associated with a dragging gesture contacting or crossing a second interface of an interaction element, for example, where a pointer exits a space in a GUI occupied by an interaction element. In examples, an exit event may serve to activate an interaction element. In examples, an activated interaction element may instruct a modification action associated with the interaction element be applied to the virtual object modify the virtual object upon the completion of the dragging gesture.

Other terms used in the present disclosure may be introduced and defined in the following description.

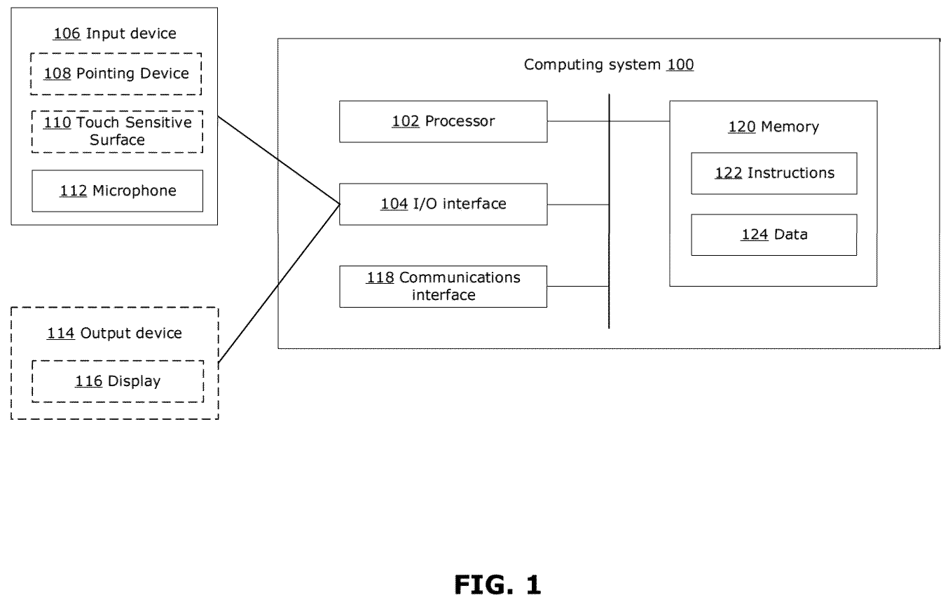

FIG. 1 is a block diagram illustrating a simplified example implementation of a computing system 100 that is suitable for implementing embodiments described herein. Examples of the present disclosure may be implemented in other computing systems, which may include components different from those discussed below. The computing system 100 may be used to execute instructions for a multimodal dragging interaction, using any of the examples described herein.

The computing system 100 includes at least one processor 102, such as a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof.

The computing system 100 may include an input/output (I/O) interface 104, which may enable interfacing with an input device 106 and/or an optional output device 114. In the example shown, the input device 106 (e.g., a keyboard, a camera, and/or a keypad) may also include a pointing device 108 (e.g., a mouse, a digital pen or stylus, etc.), a touch sensitive surface 110 or a microphone 112. In the example shown, the output device 114 (e.g., a speaker and/or a printer) may also include a display 116. In the example shown, the input device 106 and the optional output device 114 are shown as external to the computing system 100.

The computing system 100 may include an optional communications interface 118 for wired or wireless communication with other computing systems (e.g., other computing systems in a network). The communications interface 118 may include wired links (e.g., Ethernet cable) and/or wireless links (e.g., one or more antennas) for intra-network and/or inter-network communications.

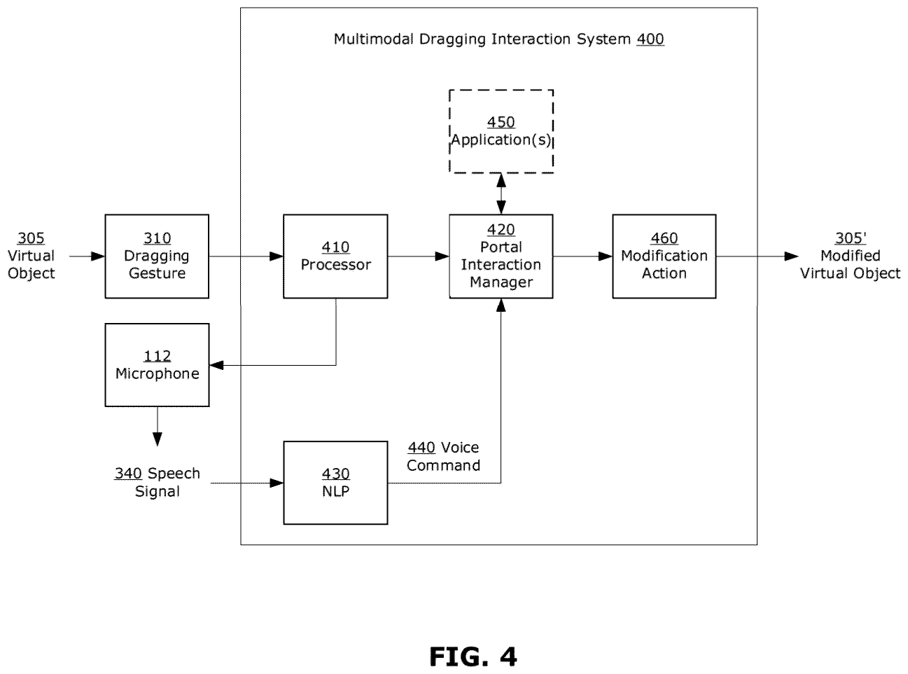

The computing system 100 may include one or more memories 120 (collectively referred to as “memory 120”), which may include a volatile or non-volatile memory (e.g., a flash memory, a random access memory (RAM), and/or a read-only memory (ROM)). The non-transitory memory 120 may store instructions 122 for execution by the processor 102, such as to carry out examples described in the present disclosure. For example, the memory 120 may store instructions for implementing any of the methods disclosed herein. The memory 120 may include other software instructions, such as for implementing an operating system (OS) and other applications or functions. The instructions 122 can include instructions for implementing the multimodal dragging interaction system 400 described below with reference to FIG. 4, among other applications. The memory 120 may also store other data 124, information, rules, policies, and machine-executable instructions described herein.

In some examples, the computing system 100 may also include one or more electronic storage units (not shown), such as a solid state drive, a hard disk drive, a magnetic disk drive and/or an optical disk drive. In some examples, data and/or instructions may be provided by an external memory (e.g., an external drive in wired or wireless communication with the computing system 100) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The storage units and/or external memory may be used in conjunction with memory 120 to implement data storage, retrieval, and caching functions of the computing system 100. The components of the computing system 100 may communicate with each other via a bus, for example.

Although FIG. 1 shows a single instance of each component, there may be multiple instances of each component in the computing system 100. Further, although the computing system 100 is illustrated as a single block, the computing system 100 may be a single physical machine or device (e.g., implemented as a single computing device, such as a single workstation, single end user device, single server, etc.), and may include mobile communications devices (smartphones), laptop computers, tablets, desktop computers, vehicle driver assistance systems, smart appliances, wearable devices, interactive kiosks, among others. In some embodiments, the computing system 100 may comprise a plurality of physical machines or devices (e.g., implemented as a cluster of machines, server, or devices). In some embodiments, the computing system 100 may be a virtualized computing system (e.g., a virtual machine, a virtual server) emulated on a cluster of physical machines or by a cloud computing system.

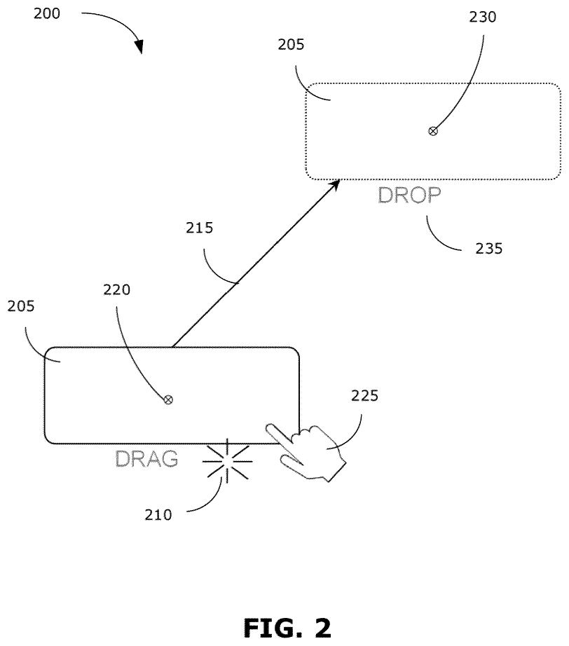

FIG. 2 shows an example of a traditional drag-and-drop interaction 200 within a graphical user interface (GUI). In examples, a traditional drag-and-drop interaction 200 is used to move a virtual object 205 from a displayed source location 220 to a displayed destination location 230. In examples, the traditional drag-and-drop interaction 200 is initiated when a pointer 225 (e.g., a mouse cursor, a digital stylus tip, or finger contact on a touch sensitive surface etc.) selects the virtual object 205, for example, by clicking 210, or otherwise “picking up” the virtual object 205. In examples, the virtual object 205 is then dragged along a dragging path 215 and the virtual object 205 is placed 235 at the destination 220, for example, by releasing a mouse button or lifting the digital stylus or finger from the touch sensitive surface 110, among others.

In examples, drag-and-drop interactions 200 in current interfaces are typically limited to moving virtual objects. In examples, in addition to moving a virtual object, users may also wish to modify it the virtual object in some way. Current approaches for modifying virtual objects in a GUI typically require several clicks or navigating through nested menus. For example, while performing the drag-and-drop interaction 200, users cannot click or tap to select modification options. In this regard, it is very difficult to modify a virtual object while performing a drag-and-drop interaction 200.

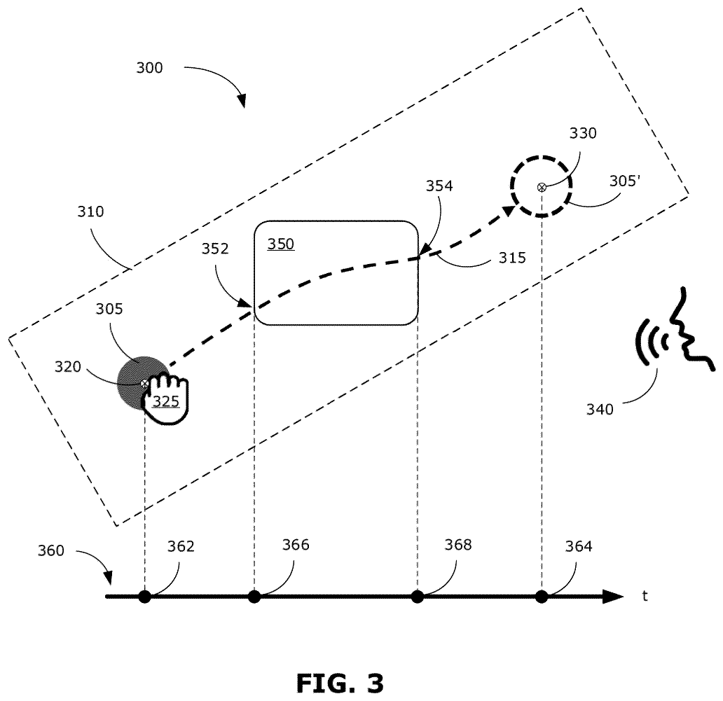

FIG. 3 illustrates an example embodiment of a multimodal dragging interaction 300 within a GUI, in accordance with examples of the present disclosure. In examples, the multimodal dragging interaction 300 may include a dragging gesture 310 and a speech signal 340, for interacting with a virtual object 305 (e.g., content, such as text, images, or shapes, one or more files or folders etc.) in the GUI. In examples, the multimodal dragging interaction 300 may modify a virtual object 305, by causing a modification action to be applied to the virtual object 305. In examples, a virtual object 305 which has been modified according to the present disclosure may be referred to as a modified virtual object 305′.

In examples, the dragging gesture 310 may move the virtual object 305 from a displayed source location 320 to a displayed destination location 330. In examples, dragging gesture 310 may be initiated when a pointer 325 (e.g., a mouse cursor, a digital stylus tip, or finger contact on a touch sensitive surface 110 etc.) selects the virtual object 305, for example, by clicking a mouse button or contacting a touch sensitive surface 110 with a stylus or finger, etc. In examples, the virtual object 305 is then dragged along a dragging path 315 where it may be placed at the displayed destination location 330, for example, by releasing a mouse button or lifting the digital stylus or finger from the touch sensitive surface 110.

In examples, the dragging path 315 may be described by a plurality of 2D coordinates (x,y) corresponding to a position on a display screen 116, relative to a display screen coordinate system, for example, starting at a displayed source location 320 and ending at a displayed destination location 330. For exemplary purposes only, the source 320 and the destination 330 are shown relative to the center of the virtual object 305, however it is understood the source 320 and the destination 330 may be relative to any point on the virtual object 305. In examples, the dragging gesture 310 may also include time information, for example, time stamps associated with a start and an end of the dragging gesture 310, among other time stamps associated with the dragging gesture 310. In examples, FIG. 3 illustrates an example horizontal axis as a function of time t (e.g., timeline 360), for example, where time stamps associated with the start of the dragging gesture tₛₜₐᵣₜ and the end t_{end} of the dragging gesture, among others, may be mapped. In examples, the time stamp associated with the start of the dragging gesture tₛₜₐᵣₜ may correspond to a dragging gesture start event 362 and the time stamp associated with the end of the dragging gesture t_{end} may correspond to a dragging gesture end event 364.

In some examples, the dragging path 315 may traverse or contact an interaction element 350 during the dragging gesture 310, for example, for instructing a modification action be applied to the virtual object 305 upon completion of the dragging gesture 310. In examples, the interaction element 350 may be a graphical interface element that resembles a button or other icon, for example, serving as a visual indicator for a specific modification action. In examples, the interaction element 350 may be activated using pointer movements during the dragging gesture 310, for example, a pointer traveling along a dragging path 315 may traverse an interaction element 350, for example, a pointer may cross a first interface 352 of the interaction element 350, and in continuing along the dragging path 315, the pointer may cross a second interface 354 of the interaction element 350. In examples, time stamps associated with the crossing of the first interface tᵢ₁ and the crossing of the second interface tᵢ₂ of the interaction element 350 may be mapped to the timeline 360. In examples, the time stamp associated with the crossing of the first interface tᵢ₁ may correspond to an entry event 366 and the time stamp associated with the crossing of the second interface tᵢ₂ may correspond to an exit event 368. In examples, an interaction element 350 may be activated by an exit event 368, among others. In other embodiments, for example, a pointer may merely touch an edge of the interaction element 350 (e.g., an edge touch event), and the interaction element 350 may be activated by the edge touch event. In examples, when an interaction element 350 is activated, a modification action may be applied to modify the virtual object 305 upon completion of the dragging gesture 310. In examples, an interaction element 350 may be configured to change in appearance when the interaction element 350 has been activated, for example, the element may change color or otherwise provide a visual indication that the interaction element 350 has been activated and that a corresponding modification action will be applied to the virtual object 305 upon completion of the dragging gesture 310.

In some examples, where an interaction element 350 has been activated in error during a dragging gesture 310, for example, where the user changes their mind after the interaction element 350 has been activated, the interaction element 350 can be deactivated during the dragging gesture 310 by reversing the dragging path 315 that traversed the interaction element 350. In examples, deactivating a respective interaction element 350 during a dragging gesture may ensure that the modification action 460 associated with the deactivated interaction element 350 will not be applied to the virtual object 305 upon completion of the dragging gesture 310. For example, if an interaction element 350 is activated by a dragging gesture 310 crossing a first interface 352 followed by a second interface 354, for example, as shown in FIG. 3 depicted by a left-to-right movement traversing the interaction element 350, then the interaction element 350 may be deactivated my reversing the direction of the dragging path 315, for example, where the dragging path 315 indicates a right-to-left motion traversing the interaction element 350, for example, crossing the second interface 354 followed by the first interface 352.

In examples, a speech signal 340 may be detected during the dragging gesture 310, where the speech signal 340 may comprise an utterance corresponding to one or more voice commands 440. In examples, the interaction element 350 may also be activated using the one or more voice commands 440, for example, as described below with reference to FIG. 4.

FIG. 4 shows a block diagram of an example multimodal dragging interaction system 400, in accordance with examples of the present disclosure. The multimodal dragging interaction system 400 may be a software that is implemented in the computing system 100 of FIG. 1, in which the processor 102 is configured to execute instructions of the multimodal dragging interaction system 400 stored in the memory 120. The multimodal dragging interaction system 400 includes a processor 410, a portal interaction manager 420 and a natural language processor (NLP) 430 and may interface with one or more applications 450, for example, to apply a modification action 460 to a virtual object 305.

The multimodal dragging interaction system 400 may receive inputs of a dragging gesture 310 associated with a virtual object 305 and a speech signal 340 and outputs the virtual object 305 having been modified (e.g., a modified virtual object 305′). In examples, the dragging gesture 310 may be associated with a movement of a pointer along a display 116 of the computing system 100, for example, a mouse cursor, a digital pen or stylus or a finger in contact with a touch sensitive surface 110, etc. In other embodiments, for example, the dragging gesture 310 could be a mid-air gesture captured by a camera of the computing system 100, for interaction with a virtual object within an AR/VR environment, among others.

In examples, the dragging gesture 310 may be detected by a processor 410 of the multimodal dragging interaction system 400, for example, the processor 410 may detect the initiation of the dragging gesture 310 (e.g., a drag-start event 362) and the end of the dragging gesture 310 (e.g., a drag-stop event 364). In examples, the processor 410 may also determine the dragging path 315 associated with a dragging gesture 310. In examples, the processor may continuously feed information related to the dragging gesture 310 to a portal interaction manager 420, for example, for determining whether the dragging gesture 310 has activated any interaction elements 350.

In examples, the portal interaction manager 420 may determine from the dragging path 315, the occurrence of an exit event 368 associated with an interaction element 350. In examples, the portal interaction manager 420 may determine a corresponding modification action 460, and may activate the interaction element 350. Examples of modification actions 460 can be styling a rich text selection (e.g., text formatting, translation, etc.), generating an image, compressing a file, among others. In examples, the portal interaction manager 420 may interface with one or more applications 450 to facilitate applying the modification action 460 to the virtual object 305 upon completion of the dragging gesture 310.

In examples, following the detection of a drag-start event 362, the processor 410 may also enable voice recognition, for example, activate or turn-on the microphone 112 or otherwise enabling the microphone 112 for detecting any audio input during the dragging gesture 310. Similarly, following the detection of a drag-stop event 364, the processor 410 may disable voice recognition, for example, deactivate or turn-off the microphone 112 or otherwise disabling the microphone 112. In this regard, the microphone 112 may be configured to be automatically enabled and disabled such that the microphone 112 is active only during a dragging gesture 310, thereby reducing the need for manually turning the microphone 112 on and off, limiting the risk of accidental activation due to background noise and/or unintended voice commands and protecting user privacy.

Once voice recognition is enabled, the microphone 112 may capture a speaker's spoken language as a speech signal 340 representative of the speaker's spoken language (otherwise known as the speaker's utterance). In examples, the speech signal 340 may be received by a NLP 430 to determine what was said by the speaker. In examples, the NLP 430 may process the speech signal 340, for example, using automatic speech recognition (ASR) for transcribing the speech signal 340 to text and generating a likely text transcript of the speaker's utterance. In examples, the NLP 430 may use natural language understanding (NLU) to extract semantic information from the text transcript of the speaker's utterance, for example, for determining whether the speaker's utterance contained an instruction or a voice command 440, such as a voice command 440 for activating one or more interaction elements 350 during the dragging gesture 310. In some embodiments, for example, speech recognition using the NLP may be provided by a cloud-based service, among others.

In examples, the portal interaction manager 420 may receive the one or more voice commands 440 and may determine a user's desire to activate a corresponding interaction element 350, based on the voice command 440. In examples, the portal interaction manager 420 may determine a corresponding modification action 460 to apply to the virtual object 305 upon completion of the dragging gesture 310, based on the voice command 440. For example, a user desiring to modify a block of text (e.g., for stylizing the font type, size, color and language) may initiate a multimodal dragging interaction for the block of text and may say “set to Times New Roman, size 47, highlighted blue, and translated to Chinese”. In examples, the NLP 430 may process the user's speech and may generate a number of voice commands 440 instructing the portal interaction manager 420 to determine corresponding modification actions 460 related to modifying the font type, size, color and language for the dragged block of text.

In some embodiments, for example, the portal interaction manager 420 may determine the modification action 460 by comparing the voice command 440 to a set of pre-determined modification actions 460 to determine a likelihood that the voice command 440 matches one or more of the pre-determined modification actions 460. In other examples, the portal interaction manager 420 may infer or predict a modification action 460 from a vague or ambiguous voice command 440, for example, the portal interaction manager 420 may include a machine learning model to predict determine a modification action 460 based on the voice command 440. In some examples, a voice command 440 may serve as a prompt to a machine learning model or other AI technique. In some embodiments, for example, the portal interaction manager 420 may include an AI extension, such as a ChatGPT™ or another generative AI extension that may receive a voice command 440 as a prompt for determining the modification action 460. In examples, the modification action 460 may include generating or modifying content (e.g., text or image content) using a generative AI model, based on the virtual object 305, for example, summarizing notes, translating text or extracting portions of text or images from the virtual object 305 based on a criteria specified in the voice command 440, among others. In some embodiments, for example, a user may desire to transform some dragged text into an image. For example, a modification action 460 may cause a modification to be applied to a text-based virtual object 305 to generate an image following the completion of a dragging gesture 310 traversing a “text-to-image” interaction element 350. In examples, a dragged text may include the phrase “a wild cat with a furry tail” and a modification action 460 may be applied to the text to generate an image based on the text. In examples, in response to viewing a live preview of the generated image, a user may issue a voice command 440 to further modify the image, for example, with the instruction “make the tail less furry, give the cat green eyes”, among others.

In examples, the portal interaction manager 420 may interface with one or more applications 450 to facilitate applying the modification action 460 to the virtual object 305 upon the completion of the dragging gesture 310.

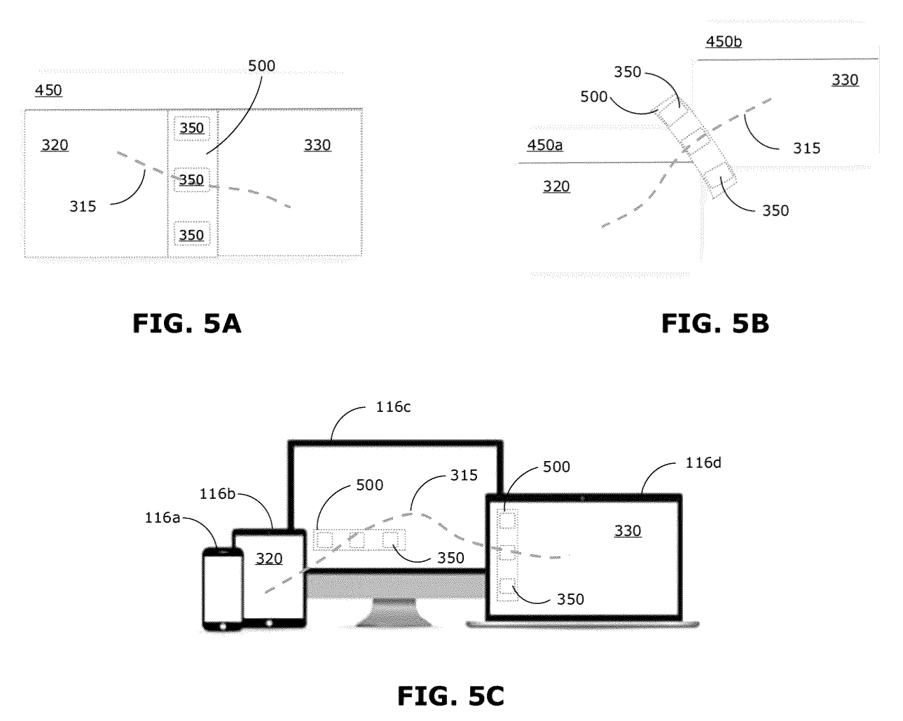

FIGS. 5A-C illustrate example embodiments of a placement of an interaction element menu 500 within a GUI, in accordance with examples of the present disclosure. In examples, an interaction element menu 500 may include one or more interaction element 350 arranged linearly or radially on the display 116, among other configurations. In some examples, the interaction element menu 500 may be configured to have a fixed location within an application 450, or in other examples the interaction element menu 500 may be dynamically displayed in response to the multimodal dragging interaction system 400 detecting that a dragging gesture 310 has been initiated. In some examples, the choice of interaction elements 350 to include in the interaction element menu 500 may depend on the application(s) 450 currently in use or the nature of the virtual object 305 or the dragging gesture 310. For example, if the virtual object being dragged is a text-based document (e.g., DOCX), the interaction element menu 500 may display interaction elements 350 configured to convert the document to PDF format and/or to compress the document. In other examples, if the virtual object 305 being dragged is a block of text within a word processing application, the interaction element menu 500 may display interaction elements 350 configured to format the text, among others.

In examples, an interaction element menu 500 can be strategically placed on a display 116 anywhere between the source 320 and destination 330 of the dragged virtual object 305. In some examples, the placement of the interaction element menu 500 on the display 116 will depend on the application(s) 450 currently in use or the nature of the virtual object 305 or the dragging gesture 310. For example, as shown in FIG. 5A, when the dragging gesture 310 is performed within an application window corresponding to a single application 450, the interaction element menu 500 may be positioned between two zones of the application 450, for example, where the first zone may be considered the source 320 and the second zone may be considered the destination 330.

In some embodiments, for example, as shown in FIG. 5B, when the dragging gesture 310 is performed between two application windows corresponding to respective applications 450a and 450b, the interaction element menu 500 may be positioned between the two application windows, for example, where the first application window may be considered the source 320 and the second application window may be considered the destination 330.

In some embodiments, for example, as shown in FIG. 5C, a dragging gesture 310 may be performed in a multi-screen scenario, across two or more displays 116 associated with two or more electronic devices. In examples, FIG. 5C illustrates a smartphone display 116a, a tablet display 116b, a monitor display 116c and a laptop display 116d, where the dragging gesture 310 begins at the tablet display 116b, and continues along the monitor display 116c and ends on the laptop display 116d. In examples, the multimodal dragging interaction system 400 may determine that a dragging path 315 of a dragging gesture 310 is approaching an edge separating two displays and may invoke an interaction element menu 500 on one of the displays. In examples, the use of interaction element menus 500 to facilitate dragging gestures 310 between windows or displays can be configured as system-level options.

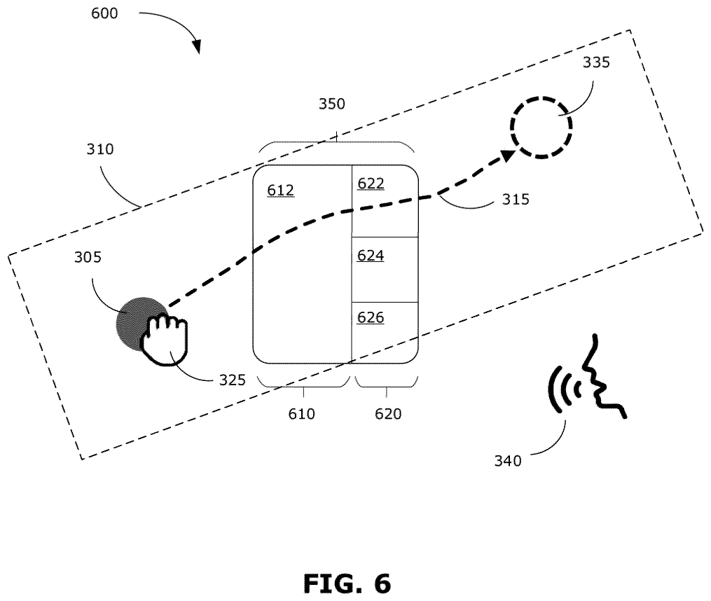

FIG. 6 illustrates another example embodiment of a multimodal dragging interaction 600 within a GUI, in accordance with examples of the present disclosure. In examples, the multimodal dragging interaction 600 may include a dragging gesture 310 along a dragging path 315 and a speech signal 340, for interacting with a virtual object 305 (e.g., content, such as text, images, or shapes, one or more files or folders etc.) in the GUI. In examples, the multimodal dragging interaction 600 may cause a modification action 460 to be applied to the virtual object 305 upon completion of the dragging gesture 310.

In some examples, the dragging path 315 may traverse or contact an interaction element 350 during the dragging gesture 310, for example, for instructing a modification action 460 be applied to the virtual object 305 upon completion of the dragging gesture 310. In examples, the interaction element 350 may be a graphical interface element that resembles a button or other icon, for example, serving as a visual indicator for a specific modification action 460. In examples, in response to crossing a first threshold 352 of the interaction element 350, the interaction element 350 of FIG. 6 may expand to reveal a parent element zone 610 and a child element zone 620, for example, where the parent element zone 610 includes one or more parent elements 612 and the child element zone 620 includes one or more child elements 622, 624, 626. For example, a parent element may represent a category of modification actions 460 (e.g., highlight text) while a child element may represent one or more options within the category (e.g., yellow highlight, green highlight, etc.), for example, where each option corresponds to a respective modification action 460. In examples, in performing the dragging gesture 310, the dragging path 315 may traverse a first parent element 612 followed by a first child element 622, causing the interaction element to be activated and causing the modification action 460 associated with child element 622 to be applied to the virtual object 305 upon completion of the dragging gesture 310. While the example interaction element 350 illustrated in FIG. 6 displays three child elements 622, 624, 626, it is understood that any number of child elements may be included, depending on the application(s) 450 currently in use or the nature of the virtual object 305 or the dragging gesture 310.

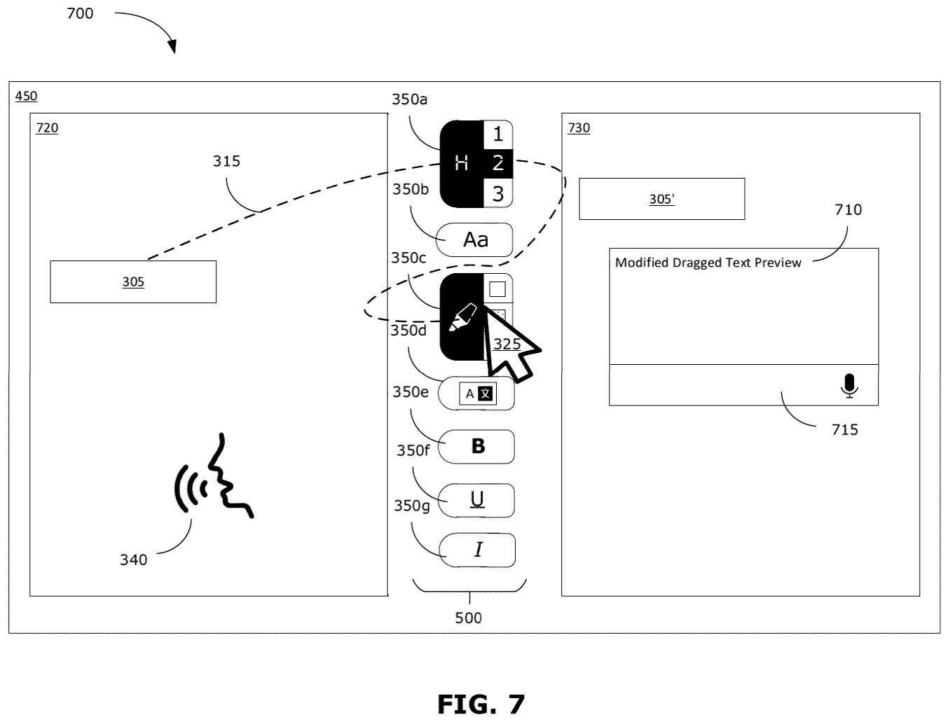

FIG. 7 illustrates another example embodiment of a multimodal dragging interaction 700 within a GUI, in accordance with examples of the present disclosure. In examples, the multimodal dragging interaction 700 may be configured within a single application 450, for example, a note taking or word processing application, among others, having a source region 720 and a destination region 730 separated by a fixed interaction element menu 500, for example, arranged as a bridge between the source region 720 and the destination region 730. In examples, the multimodal dragging interaction 700 may include a dragging gesture 310 performed by a cursor 325 along a dragging path 315 and a speech signal 340, for interacting with a virtual object 305 displayed in the GUI.

In some examples, the interaction element menu 500 of FIG. 7 is representative of a set of modification actions 460 that a user may desire to apply to a text-based virtual object 305, for example, while taking notes during a lecture. In examples, application 450 may provide a live text transcript of the lecture in the source region 720 and a user may desire to drag blocks or snippets of text into a personalized lecture note in the destination region 730. In examples, the interaction element menu 500 includes an interaction element 350a for formatting the style of a paragraph, for example, as a heading 1, heading 2 or heading 3 style.

In examples, the interaction element menu 500 also includes an interaction element 350b for formatting the font type of a block of text. In examples, the interaction element menu 500 includes an interaction element 350c for formatting the highlight color of a block of text, for example, having three highlight color options. In examples, the interaction element menu 500 also includes an interaction element 350d for translating a block of text. In examples, the interaction element menu 500 also includes interaction elements 350e, 350f and 350g for formatting the style of a block of text, for example, as bold, underline and italics, respectively. In the example of FIG. 7, the virtual object 305 may be modified by dragging the virtual object 305 in a dragging gesture 310 through one or more interaction elements 350 before completing the dragging gesture 310 and placing the virtual object 305, modified by one or more corresponding modification actions 460, in the destination region 730. For example, dragging path 315 is shown to have traversed interaction element 350a, with effect that interaction element 350a is activated or toggled “on” and header style 2 is indicated as selected. Similarly, as shown by the position of cursor 325, interaction element 350c is in the process of being activated or toggled “on”, as the cursor navigates the associated parent and child elements of interaction element 350c to instruct the application of a highlight color to the text.

In examples, upon the completion of the dragging gesture 310, the virtual object 305, modified by the one or more modification actions 460 may be placed in the destination zone 730 (e.g., shown as modified virtual object 305′) For example, the virtual object 305 may be a block of text, and the block of text may be modified with a heading 2 style and highlighted in yellow. In examples, also shown in the destination region 730 is a preview dialog 710 for previewing the modification actions 460 in real-time and a text transcript dialog 715 for displaying a text transcript of any voice commands 440.

As shown in the example of FIG. 7, multiple interaction elements 350 may be activated and/or deactivated in a single dragging interaction 700, for example, the modification actions 460 associated with each interaction element 350 may stack. In examples, stacking may occur when multiple interaction elements 350 are activated during a single dragging gesture 310, and/or using voice commands 440.

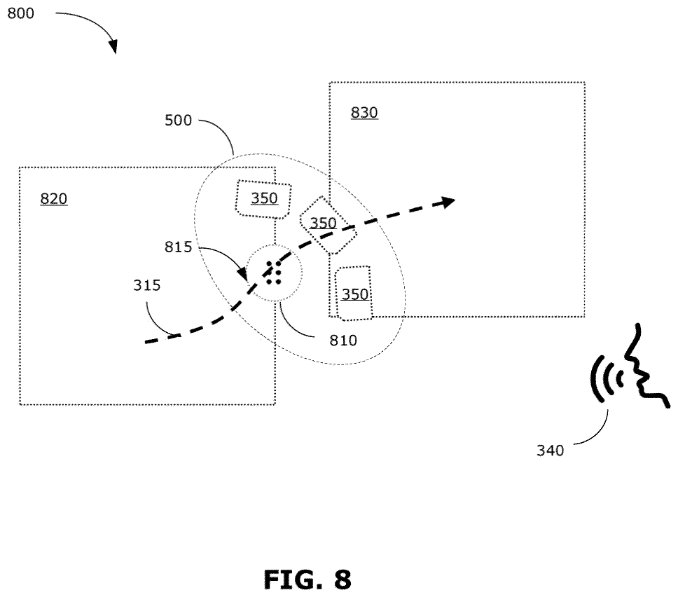

FIG. 8 illustrates another example embodiment of a multimodal dragging interaction 800 within a GUI, in accordance with examples of the present disclosure. In examples, the multimodal dragging interaction 800 may be configured to traverse two application windows, where the first application window may be considered a source region 820 and the second application window may be considered a destination region 830. In examples, the interaction element menu 500 may be positioned between the two application windows, for example, arranged radially between the source region 820 and the destination region 830 in response to an initiation of a dragging gesture 310.

In examples where the location of the source region 820 and the destination region 830 are not fixed, a dynamic layout for the interaction element menu 500 may be used. In examples, a dynamic interaction element menu 500 is configured to first appear on the display 116 as a dynamic interaction initiation element 810, for example, as a circle-shaped interaction element or portal element, among other configurations. In examples, the position of the dynamic interaction initiation element 810 on the display 116 may depend on the trajectory of a dragging gesture 310, for example, based on the direction of a cursor trail after a drag-start event 362 has been detected.

In examples, a user may reveal the interaction element menu 500 on the display 116 by navigating the dragging gesture 310 through the dynamic interaction initiation element 810. For example, a pointer traveling along a dragging path 315 may cross a first interface 815 of the dynamic interaction initiation element 810, and one or more interaction elements 350 may appear on the display 116 and may be arranged as a partial radial menu around the dynamic interaction initiation element 810. In examples, the position of the one or more interaction elements 350 may depend on the trajectory of the dragging gesture 310 at the instant that the pointer crosses the first interface 815 of the dynamic interaction initiation element 810. In other examples, the interaction elements 350 may be arranged on the display 116 to enable space between each of the interaction elements 350 for navigating the dragging gesture 310 from source region 820 to destination region 830 without accidentally activating one or more interaction elements 350.

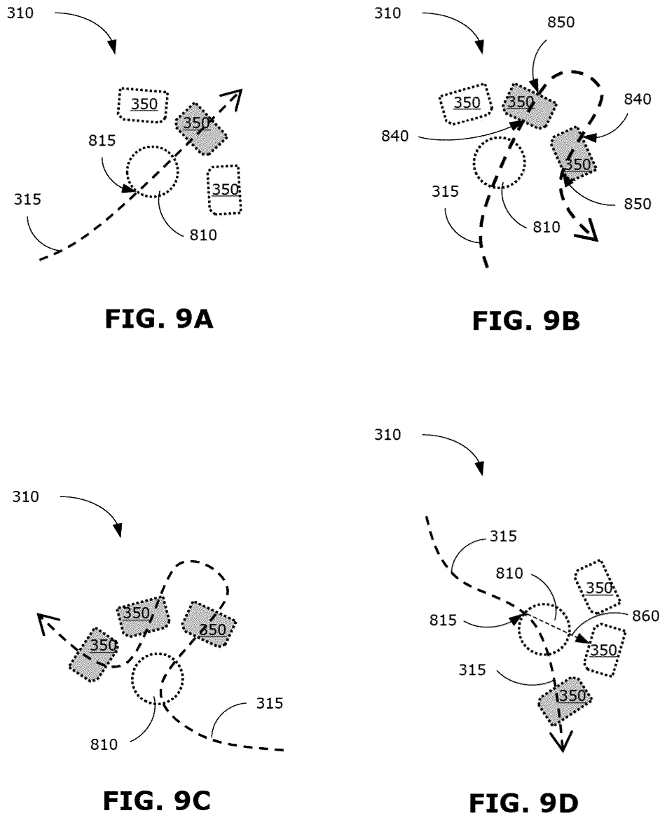

FIG. 9A-D illustrate example embodiments of dragging gestures 310 to activate one or more interaction elements 350 in a dynamic radial interaction element menu 500, in accordance with examples of the present disclosure. For example, as shown in FIG. 9A, a pointer navigating along a dragging path 315 intersects a dynamic interaction initiation element 810, and in response to the pointer crossing a first interface 815 of the dynamic interaction initiation element 810, one or more interaction elements 350 may be revealed in the GUI and arranged in a radial configuration around the dynamic interaction initiation element 810. In examples, the positioning of the one or more interaction elements 350 around the dynamic interaction initiation element 810 may be determined by the direction of motion of the pointer along the dragging path 315 at the instant that the pointer crosses the first interface 815. In examples, the dragging path 315 is shown in FIG. 9A to traverse one interaction element 350 for activating the respective interaction element 350. In examples, the appearance of the activated interaction element 350 may be updated to indicate to a user that the interaction element 350 has been activated.

In the example dragging gesture 310 shown in FIG. 9B, a pointer navigating along a dragging path 315 is shown to traverse and activate two interaction elements 350. For example, the pointer traveling along the dragging path 315 may cross a first interface 840 of an interaction element 350 that may be associated with an entry event 366 and in continuing along the dragging path 315, the pointer may cross a second interface 850 of the same interaction element 350 that may be associated with an exit event 368. In examples, as shown in FIG. 9B, the location of the first interface 840 with respect to the second interface 850 is not fixed or dependent on position, for example, pointer traveling along a dragging path 315 may traverse an interaction element 350 with any trajectory in any direction. In examples, the appearance of the activated interaction elements 350 may also be updated to indicate to a user that the interaction elements 350 have been activated.

In the example dragging gesture 310 shown in FIG. 9C, a pointer navigating along a dragging path 315 is shown to traverse and activate three interaction elements 350, where the dragging path 315 may follow any trajectory that enables the user to traverse one or more interaction elements 350. In the example dragging gesture 310 shown in FIG. 9D, a pointer navigating along a dragging path 315 is shown to traverse and activate one interaction element 350. It is clear from the example of FIG. 9D that the arrangement of the one or more interaction elements 350 in a dynamic radial menu is dependent on the trajectory of pointer motion at the instant that the pointer crosses the first interface 815 of the dynamic interaction initiation element 810. For example, dashed line 860 is a projection of the pointer trajectory at the instant that the pointer crosses the first interface 815 of the dynamic interaction initiation element 810 and serves as an anchor for the arrangement of the interaction elements 350 in the radial menu.

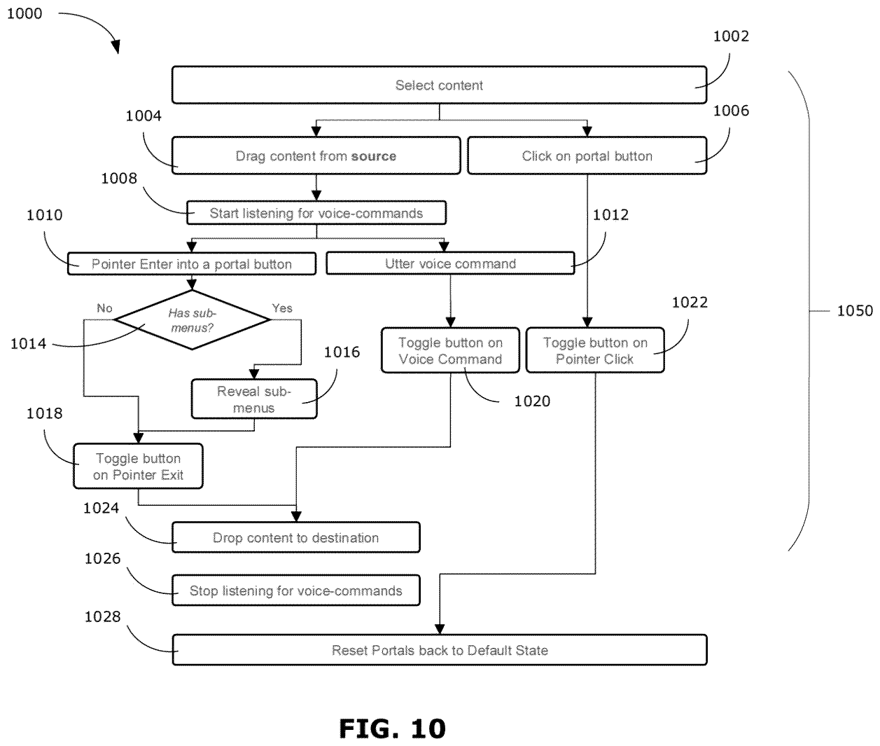

FIG. 10 is a flowchart illustrating an example algorithm 1000 for a multimodal dragging interaction 1050, in accordance with examples of the present disclosure. In examples, the multimodal dragging interaction 1050 may enable the modification of one or more dragged virtual objects 305 upon completion of a dragging gesture 310, by activating one or more interaction elements 350 based on the dragging gesture 310 and a voice command 440. In examples, algorithm 1000 begins at step 1002 in which a virtual object 305 is selected. In examples, a virtual object 305 may be selected using a “click-select” action, for example, by clicking an icon or graphical element associated with the virtual object 305, for example, a file or folder icon, among other types of virtual objects. In other examples, a virtual object 305 may be selected using a “drag-select” action, for example, clicking and dragging to highlight anything (e.g., text, images, shapes, icons etc.) from the beginning to the end of the drag. In examples, the selected content may collectively be referred to as the virtual object 305 to be modified.

In examples, at step 1004, the a dragging gesture 310 may be initiated (e.g., dragging gesture start event 362) to drag the selected virtual object 305 from a source 320 to a destination 330. At step 1008, upon detecting a dragging gesture start event 362, voice recognition may be enabled, for example, a microphone 112 may be activated to enable the microphone 112 to detect any audio input during the dragging gesture 310.

In examples, at step 1010, an entry event 366 may be detected, for example, the dragging gesture 310 may navigate along a dragging path 315 that crosses a first interface 352 of one or more interaction elements 350 in a fixed interaction element menu 500. In examples, depending on the configuration of the interaction element 350, the algorithm may determine at step 1014 whether the interaction element 350 is configured to include sub-menus, for example, including a parent zone 610 and a child zone 620. In examples, if the interaction element 350 is not configured to enable sub-menus, the algorithm continues to step 1018 where the interaction element 350 is activated upon detection of an exit event 368, for example, when the pointer navigating along the dragging path 315 crosses a second interface 354 of the interaction element 350. In examples, if the interaction element 350 is configured to include sub-menus, the algorithm progresses to step 1016 in which the sub-menus are revealed. In examples, an appearance of the interaction element 350 may be altered to reveal a parent element 612 and one or more child elements 622, 624, 626 etc. (for example, as described with respect to FIG. 6). In examples, the dragging gesture 310 may traverse the parent element 612 and one of the child elements and the algorithm continues to step 1018 where the interaction element 350 is activated upon detection of an exit event 368.

In examples, at step 1012, the microphone may detect a speech signal 340 including one or more voice commands 440. In examples, the multimodal dragging interaction system 400 may receive and process the speech signal 340 to generate a voice command 440. At step 1020, a respective interaction element 350 may be activated based on the voice command 440.

In examples, steps 1010 to 1020 may be repeated in an iterative manner to activate additional interaction elements 350 of a plurality of interaction elements 350 within the fixed interaction element menu 500, during the multimodal dragging interaction 1050. In examples, the multimodal dragging interaction 1050 is completed at step 1024 when a dragging gesture end event 364 is detected. In examples, one or more modification actions 460 corresponding to the one or more activated interaction elements 350 may be applied to the selected virtual object 305 upon completion of the dragging gesture 310, and the modified virtual object 305′ is placed at the destination 330. In examples, at step 1026, upon detecting a dragging gesture end event 364, voice recognition may be disabled, for example, the microphone 112 may be deactivated and may stop listening for any voice commands 440.

In some embodiments, for example, the multimodal dragging interaction 1050 may also activate an interaction element 350 by clicking on one or more interaction elements 350 rather than performing a dragging gesture 310. In examples, at step 1006, after selecting a virtual object 305 (e.g., step 1002), a click-select action may be applied to one or more interaction elements 350 to select the interaction element 350 for interaction. At step 1022, a subsequent click-select action may be applied to the selected interaction element 350 to activate the interaction element 350.

In examples, following the completion of the multimodal dragging interaction 1050, all interaction elements 350 may be reset to their default state at step 1028.

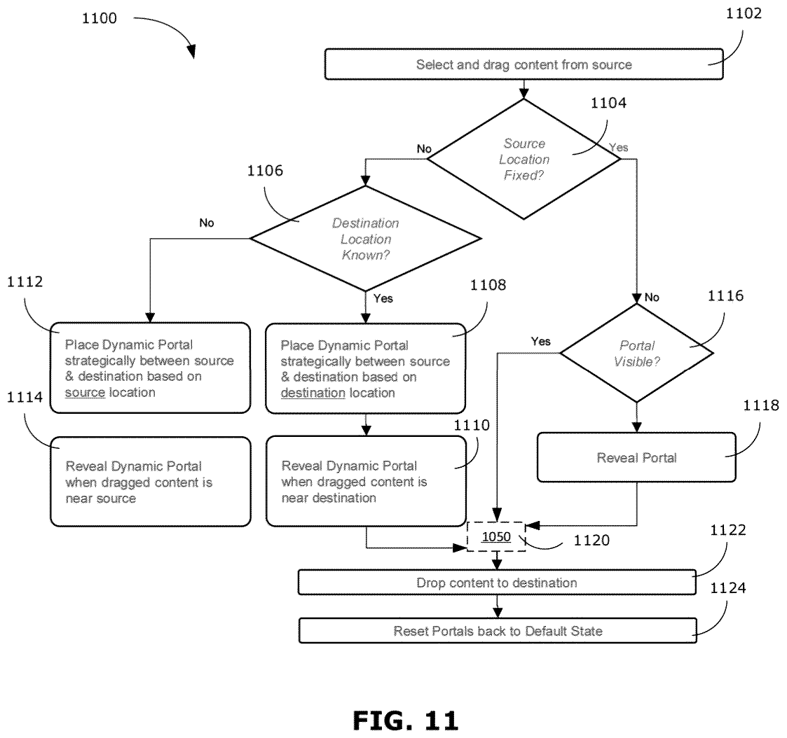

FIG. 11 is a flowchart illustrating an example algorithm 1100 for determining the placement and layout of a interaction element menu 500, in accordance with examples of the present disclosure. In examples, the interaction element menu 500 may be fixed in position in a GUI or may be dynamically positioned depending on the application 450 in use and further based on the source 320 and destination 330 of the dragged virtual object 305. In examples, algorithm 1100 begins at step 1102 in which a virtual object 305 is selected. In examples, a virtual object 305 may be selected using a “click-select” action, for example, by clicking an icon or graphical element associated with the virtual object 305, for example, a file or folder icon, among other types of virtual objects. In other examples, a virtual object 305 may be selected using a “drag-select” action, for example, clicking and dragging to highlight anything (e.g., text, images, shapes, icons etc.) from the beginning to the end of the drag-select action. In examples, the selected content may collectively be referred to as the virtual object 305 to be modified. In examples, following the selection of the virtual object 305, a dragging gesture 310 may be initiated (e.g., dragging gesture start event 362) to drag the selected virtual object 305 from a source 320 to a destination 330.

In examples, at step 1104, the algorithm 1100 determines whether the source 320 of the virtual object 305 is fixed. If the source 320 is fixed, the algorithm progresses to step 1116, where the algorithm determines whether the interaction element menu 500 is already displayed in the GUI. In examples, if the interaction element menu 500 is already displayed (e.g., an example of a fixed and displayed interaction element menu 500 is provided in FIG. 7), a user may proceed to perform a multimodal dragging interaction 1050 at step 1120, for example, as described with respect to FIG. 10. In examples, if the interaction element menu 500 is not displayed, the algorithm may proceed to step 1118 in which the interaction element menu 500 is revealed for display. A user may then proceed to perform a multimodal dragging interaction 1050 at step 1120, for example, as described with respect to FIG. 10.

In examples, if at step 1104, the source 320 is determined not to be fixed, the algorithm proceeds to step 1106 to determine if the destination 330 is known. In examples, if the destination 330 is known, the interaction element menu 500 can be dynamically placed in the GUI (step 1108) and revealed on the display 116 (step 1110) at a position that is relatively near to the destination 330, for example, for engaging with interaction elements 350 to modify the selected virtual object 305 towards the end of a corresponding dragging gesture 310. If on the other hand, only the source 320 location is known, the interaction element menu 500 can be placed near the source 320. A user may then proceed to perform a multimodal dragging interaction 1050 at step 1120, for example, as described with respect to FIG. 10.

In examples, if at step 1106, the destination 330 is not known, the interaction element menu 500 can be dynamically placed in the GUI (step 1112) and revealed on the display 116 (step 1114) at a position that is relatively near to the source 320, and where the configuration of the interaction element menu 500 may be based on the pointer trajectory at the beginning of the dragging gesture 310. A user may then proceed to perform a multimodal dragging interaction 1050 at step 1120, for example, as described with respect to FIG. 10.

In examples, following the completion of the multimodal dragging interaction 1050, at step 1122 the virtual object 305, modified by one or more modification actions 460, is placed at a destination 330. In examples, all interaction elements 350 may be reset to their default state at step 1124.

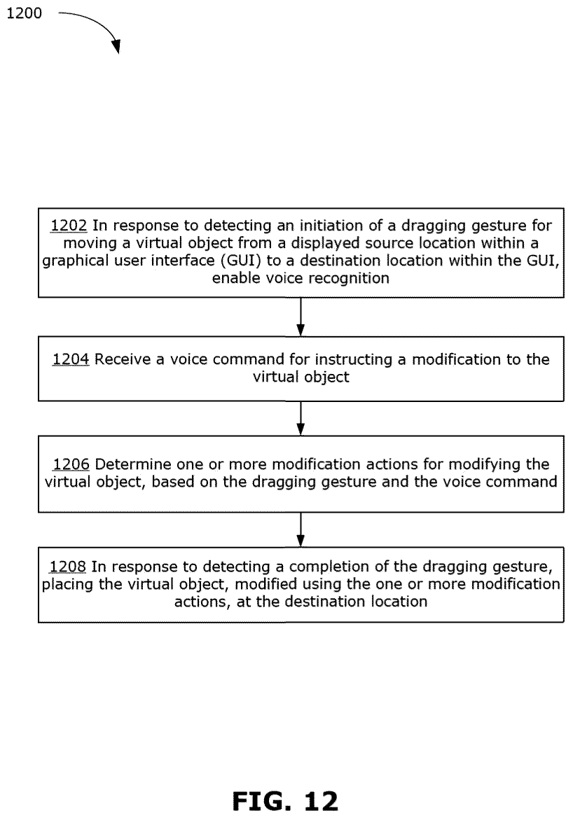

FIG. 12 is a flowchart illustrating an example computer implemented method 1200 for modifying a virtual object 305 based on a multimodal dragging gesture 310, in accordance with examples of the present disclosure. The method 1200 may be performed by the computing system 100. For example, the processor 102 may execute computer readable instructions (which may be stored in the memory 120) to cause the computing system 100 to perform the method 1200. The method 1200 may be performed using a single physical machine (e.g., a workstation or server), a plurality of physical machines working together (e.g., a server cluster), or cloud-based resources (e.g., using virtual resources on a cloud computing platform).

Method 1200 begins with step 1202 in which, in response to detecting an initiation of a dragging gesture 310 for moving a virtual object 305 from a displayed source 320 location within a graphical user interface (GUI) to a displayed destination 330 location within the GUI, a voice recognition is enabled In examples, a dragging gesture 310 may be initiated when a drag-start event 362 is detected, for example, a pointer event signifying the start of the dragging gesture 310.

At step 1204, a voice command 440 for instructing a modification to the virtual object 305 may be received. For example, a microphone 112 may capture an utterance and a speech signal 340 representative of the utterance may be generated. In examples, the speech signal 340 may be processed to determine whether the speaker's utterance contained an instruction or a voice command 440.

At step 1206, one or more modification actions 460 for modifying the virtual object 305, may be determined, based on the dragging gesture 310 and the voice command 440. In examples, the portal interaction manager 420 may determine from the dragging gesture 310 whether a dragging path 315 has traversed or otherwise contacted one or more interaction elements 350 corresponding to the one or more modification actions 460. In other examples, the portal interaction manager 420 may determine from the voice command 440, a user's desire to activate an interaction element 350 corresponding to the one or more modification actions 460.

At step 1208, in response to detecting a completion of the dragging gesture 310, the virtual object 305, modified using the one or more modification actions 460, may be placed at the destination 330. In examples, a dragging gesture 310 may be completed when a drag-stop event 364 is detected, for example, a pointer release event (e.g., mouse release, removing a stylus or finger from a touch sensitive surface, etc.). In examples, the portal interaction manager 420 may interface with one or more applications 450 to facilitate applying the one or more modification actions 460 to the virtual object 305.

Although examples have been described in the context of modifying a virtual object in a GUI, for example, by a dragging gesture generated with a pointing device or by a touch gesture on a touch sensitive surface, it should be understood that the present disclosure is not limited to interactions in a GUI environment. For example, the dragging gesture of present disclosure may also be representative of a mid-air gesture, for example, a captured by an external camera tracking system or computer vision system, for modifying a virtual object within an AR/VR environment, among others.

Various embodiments of the present disclosure having been thus described in detail by way of example, it will be apparent to those skilled in the art that variations and modifications may be made without departing from the disclosure. The disclosure includes all such variations and modifications as fall within the scope of the appended claims.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration in-formation, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer implemented method comprising:
in response to detecting an initiation of a dragging gesture for moving a virtual object from a displayed source location within a graphical user interface (GUI) to a displayed destination location within the GUI, enabling voice recognition;
receiving a voice command for instructing a modification to the virtual object;
determining one or more modification actions for modifying the virtual object, based on the dragging gesture and the voice command; and
in response to detecting a completion of the dragging gesture, placing the virtual object, modified using the one or more modification actions, at the displayed destination location.

2. The method of claim 1, wherein the GUI includes one or more interactive elements, each of the one or more interactive elements being associated with a respective selectable modification action for modifying the virtual object.

3. The method of claim 2, wherein determining the one or more modification actions comprises:
determining at least one of the one or more interactive elements were traversed by a dragging path of the dragging gesture; and
for each of the traversed portal elements:
activating the interactive element.

4. The method of claim 2, wherein determining the one or more modification actions comprises:
determining that the voice command corresponds to a modification action associated with at least a corresponding one of the one or more interactive elements; and
for each of the at least corresponding one of the one or more interactive elements:
activating the portal element.

5. The method of claim 3, further comprising:
for each activated interactive element of the one or more interactive elements:
altering an appearance of the activated interactive element.

6. The method of claim 3, further comprising, prior to activating the interactive element:
altering an appearance of the interactive element to include a parent element representing a category of modification actions and at least one child element representing at least one of the one or more modification actions.

7. The method of claim 2, wherein the one or more interactive elements are arranged in an interactive element menu, the interactive element menu being displayed at a fixed position on a display of an electronic device.

8. The method of claim 2, wherein the one or more interactive elements are arranged in an interactive element menu, the interactive element menu being dynamically positioned on a display of an electronic device based on a displayed location of the source.

9. The method of claim 2, wherein the one or more interactive elements are arranged in an interactive element menu, the interactive element menu being dynamically positioned on a display of an electronic device based on the displayed location of the destination.

10. The method of claim 1, wherein enabling voice recognition includes activating a microphone for receiving a speech signal.

11. The method of claim 10, further comprising:
in response to detecting the completion of the dragging gesture, deactivating the microphone.

12. The method of claim 1, wherein the dragging gesture is representative of a movement of one of:
a pointer within the GUI;
a digital pen or stylus in contact with a touch sensitive surface of a display of an electronic device; or
a finger in contact with the touch sensitive surface of the display of the electronic device.

13. A system comprising:
one or more processors; and
a memory storing machine-executable instructions which, when executed by the processor device, cause the system to:
in response to detecting an initiation of a dragging gesture for moving a virtual object from a displayed source location within a graphical user interface (GUI) to a displayed destination location within the GUI, enable voice recognition;
receive a voice command for instructing a modification to the virtual object;
determine one or more modification actions for modifying the virtual object, based on the dragging gesture and the voice command; and
in response to detecting a completion of the dragging gesture, place the virtual object, modified using the one or more modification actions, at the displayed destination location.

14. The system of claim 13, wherein the GUI includes one or more interactive elements, each of the one or more interactive elements being associated with a respective selectable modification action for modifying the virtual object.

15. The method of claim 14, wherein the machine-executable instructions, when executed by the one or more processors to determine the one or more modification actions, further cause the system to:
determine at least one of the one or more interactive elements were traversed by a dragging path of the dragging gesture; and
for each of the traversed portal elements:
activate the interactive element.

16. The system of claim 14, wherein the machine-executable instructions, when executed by the one or more processors to determine the one or more modification actions, further cause the system to:
determine that the voice command corresponds to a modification action associated with at least a corresponding one of the one or more interactive elements; and
for each of the at least corresponding one of the one or more interactive elements:
activate the portal element.

17. The system of claim 15, wherein the machine-executable instructions, when executed by the one or more processors, further cause the system to:
for each activated interactive element of the one or more interactive elements:
alter an appearance of the activated interactive element.

18. The system of claim 15, wherein the machine-executable instructions, when executed by the one or more processors, further cause the system to:
prior to activating the interactive element:
alter an appearance of the interactive element to include a parent element representing a category of modification actions and at least one child element representing at least one of the one or more modification actions.

19. The system of claim 13, wherein the dragging gesture is representative of a movement of one of:
a pointer within the GUI;
a digital pen or stylus in contact with a touch sensitive surface of a display of an electronic device; or
a finger in contact with the touch sensitive surface of the display of the electronic device.

20. A non-transitory computer-readable medium having machine-executable instructions stored thereon which, when executed by a processor of a device, cause the device to:
in response to detecting an initiation of a dragging gesture for moving a virtual object from a displayed source location within a graphical user interface (GUI) to a displayed destination location within the GUI, enable voice recognition;
receive a voice command for instructing a modification to the virtual object;
determine one or more modification actions for modifying the virtual object, based on the dragging gesture and the voice command; and
in response to detecting a completion of the dragging gesture, place the virtual object, modified using the one or more modification actions, at the displayed destination location.
